(19) United States
(12) Patent Application Publication
(10) Pub. No.: US 2017/0329665 A1
(43) Pub. Date: Nov. 16, 2017

(54) COMMUNITY CONTENT IDENTIFICATION

(71) Applicant: International Business Machines Corporation, Armonk, NY (US)

(72) Inventors: Kelly Abuelsaad, Somers, NY (US); Lisa Seacat DeLuca, Baltimore, MD (US); Soobaek Jang, Hamden, CT (US); Daniel C. Krook, Fairfield, CT (US)

(21) Appl. No.: 15/668,805

(22) Filed: Aug. 4, 2017

Related U.S. Application Data
(63) Continuation of application No. 15/145,457, filed on May 3, 2016.

(51) Int. Cl. G06F 11/07; H04L 12/58; G06F 11/00

(52) U.S. Cl. CPC G06F 11/0769; H04L 51/16; G06F 11/006; G06F 11/079; H04L 51/046

(57) ABSTRACT

In one embodiment, a method for community content identification is provided. The method includes identifying one or more error messages from software running on a cloud instance. The method further includes determining relevance of content items of community content to the identified error messages. The method further includes assigning weights to the content items of the community content based on their determined relevance, wherein content items having high relevance to the identified error messages are assigned a higher weight than content items determined not relevant to the error messages and displaying content items according to the assigned weights.

### BACKGROUND

The present invention relates generally to the field of online support communities and forums, and more particularly to community content identification.

An online support community, also referred to as an Internet forum, or message board, is typically, an online discussion site where users can hold conversations in the form of posted messages. Users may also search the online support community using specific words and/or phrases to find specific threads. A thread, also referred to as a topic, is generally considered to be a collection of any number of posts and can contain multiple posts from one or more users.

### SUMMARY

Embodiments of the present invention disclose a method, computer program product, and system for community content identification. The method includes identifying one or more error messages from software running on a cloud instance. The method further includes determining relevance of content items of community content to the identified error messages. The method further includes assigning weights to the content items of the community content based on their determined relevance, wherein content items having high relevance to the identified error messages are assigned a higher weight than content items determined not relevant to the error messages and displaying content items according to the assigned weights.

### BRIEF DESCRIPTION OF THE DRAWINGS

FIG. 1 depicts a cloud computing environment, in an embodiment in accordance with the present invention.

FIG. 2 depicts abstraction model layers, in an embodiment in accordance with the present invention.

FIG. 3 is a functional block diagram illustrating an online support environment, in an embodiment in accordance with the present invention.

FIG. 4 is a flowchart depicting operational steps of a search refining software, on a server computer within the online support environment of FIG. 3, for highlighting topics of interest in an online forum based on active error/console messages and/or cloud resource activity, in an embodiment in accordance with the present invention.

FIG. 5A is a diagram illustrating results of a search of a command performed on an online forum, using a computing device within the online support environment of FIG. 3, in an embodiment in accordance with the present invention.

FIG. 5B is a diagram of a received error for a command, using a computing device within the online support environment of FIG. 3, in an embodiment in accordance with the present invention.

FIG. 5C is a diagram illustrating results of a search of a command performed on an online forum after a search refining software analyzes posts in the forum, using a computing device within the online support environment of FIG. 3, in an embodiment in accordance with the present invention.

FIG. 6 depicts a block diagram of components of the server computer executing the search refining software, in an embodiment in accordance with the present invention.

### DETAILED DESCRIPTION

Embodiments in accordance with the present invention recognize that online support communities and forums are a common resource for organizations that require assistance or may be attempting to fix error messages and address system failures such as outages. These online support communities allow users to browse and submit content. These online support communities can aid a user in determining solutions to error messages and system failures. While some communities offer great search capabilities that allow users to find topics that might be of interest to them, in some instances, other communities may not have great search capabilities. In other words, some communities need a way to highlight those topics of interest to individuals based on the user's or organization's active resources. As such, embodiments in accordance with the present invention provide solutions for highlighting topics in communities that are of interest (e.g., solutions to error messages) to users based on identified error and system failures.

Embodiments in accordance with the present invention will now be described in detail with reference to the Figures.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

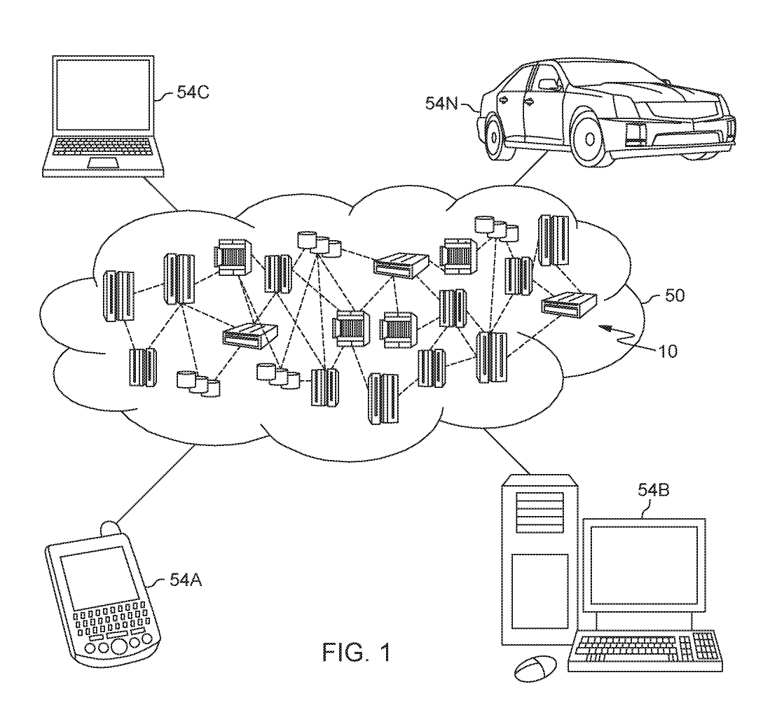

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Cloud computing nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that cloud computing nodes 10 and cloud computing environment 50 can communicate with any type of computerized device over any type of network and/or network addressable connection (e.g., using a web browser).

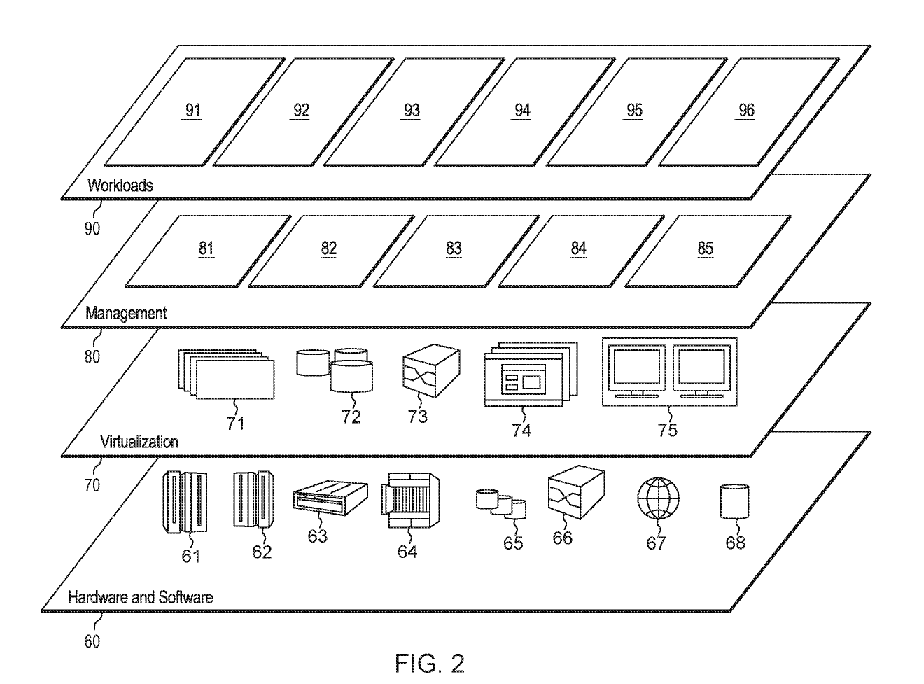

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and search refining software 96.

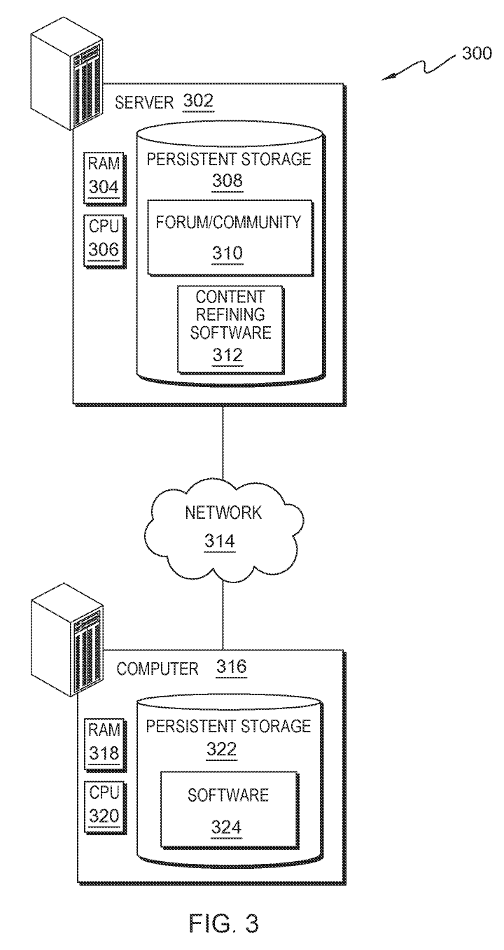

FIG. 3 is a functional block diagram illustrating online support environment 300, in an embodiment in accordance with the present invention. Online support environment 300 includes server 302, computer 316, and other computing devices (not shown), all interconnected over network 314. Server 302 includes random access memory (RAM) 304, central processing unit (CPU) 306, and persistent storage 308. Server 302 may be a Web server, or any other electronic device or computing system, capable of processing program instructions and receiving and sending data. In some embodiments, server 302 may be a laptop computer, a tablet computer, a netbook computer, a personal computer (PC), a desktop computer, a personal digital assistant (PDA), a smart phone, or any programmable electronic device capable of communicating over a data connection to network 314. In other embodiments, server 302 may represent server computing systems utilizing multiple computers as a server system, such as in an online support environment. In general, server 302 is representative of any electronic device or combinations of electronic devices capable of executing machine-readable program instructions and communicating with computer 316 via network 314 and with various components and devices (not shown) within online support environment 300.

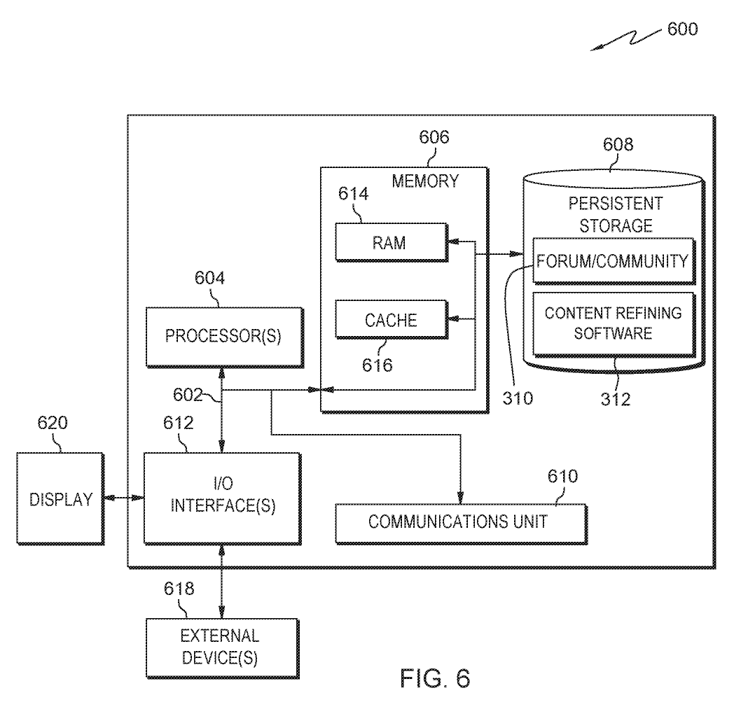

Server 302 includes persistent storage 308. Persistent storage 308 may, for example, be a hard disk drive. Alternatively, or in addition to a magnetic hard disk drive, persistent storage 308 may include a solid state hard drive, a semiconductor storage device, read-only memory (ROM), erasable programmable read-only memory (EPROM), flash memory, or any other computer-readable storage medium that is capable of storing program instructions or digital information. Server 302 may include internal and external hardware components, as depicted and described in further detail with respect to FIG. 6.

Forum/community 310 and content refining software 312 are stored in persistent storage 308 and enables server 302 to identify content in electronic message threads. An electronic message thread as used herein, can refer to messages in an online community and/or forum. For example, an online community may be a forum. In another example embodiment, the online community can be a message board on a web page. In other example embodiments, the online community can include, but is not limited to a blog, wiki, a search engine, a support portal, a social networking site, or any other site that includes a message, a post, and/or a status update generated by users. In yet another example, the online community can comprise one or more sets of computer programs executing in a cloud instance, also referred to as a cloud environment. Persistent storage 308 also includes operating system software (not shown), that enables server 302 to communicate with computer 316 and other computing devices (not shown) of online support environment 300 over a data connection via network 314. In other example embodiments, forum/community 310 and content refining software 312 may be components of an operating system software.

Forum/community 310 is a computer program, or sets of computer programs, that are stored in persistent storage 308. In one example embodiment, forum/community 310 may be an online forum. In another example embodiment, forum/community 310 may be a blog or a wiki. Forum/community 310 enables a user to search for solutions to one or more topics of interest. Examples of topics of interest within forum/community 310 may include, but are not limited to, one of the following: (i) one or more solutions to one or more error messages, (ii) one or more solutions to one or more system failures, such as a system outage, and (iii) one or more solutions or suggestions to one or more system configuration issues. In other example embodiments, forum/community 310 may include social networking capabilities. For example, a user of forum/community 310 may be a website or other application that enables users to communicate with each other by posting information, comments, messages, and/or images.

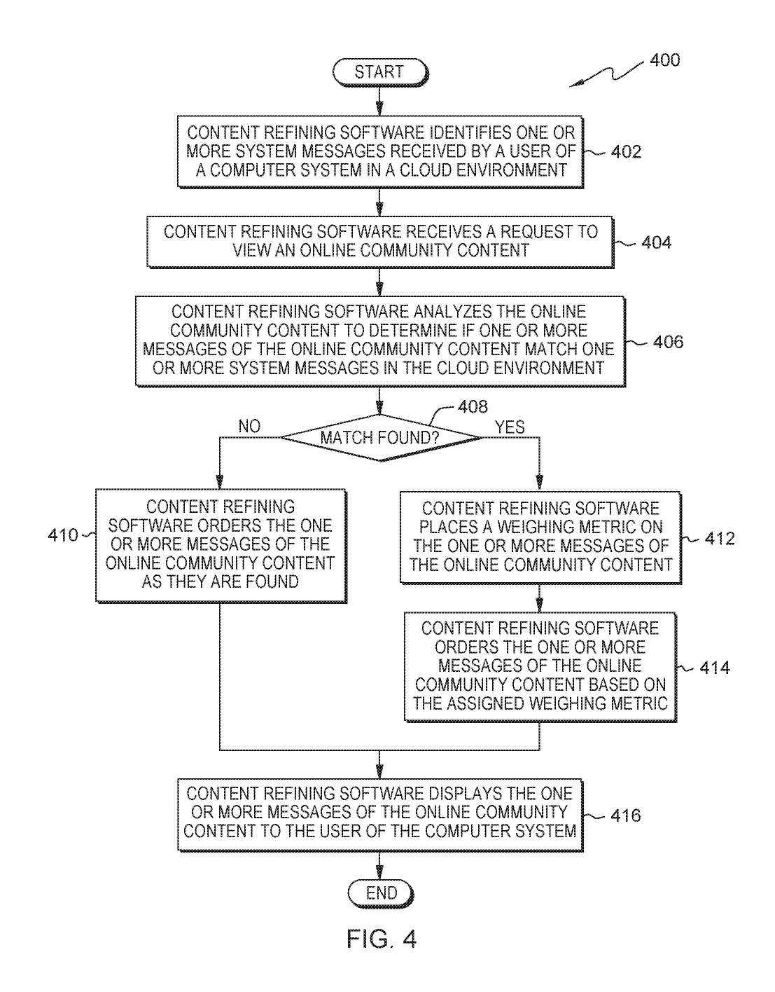

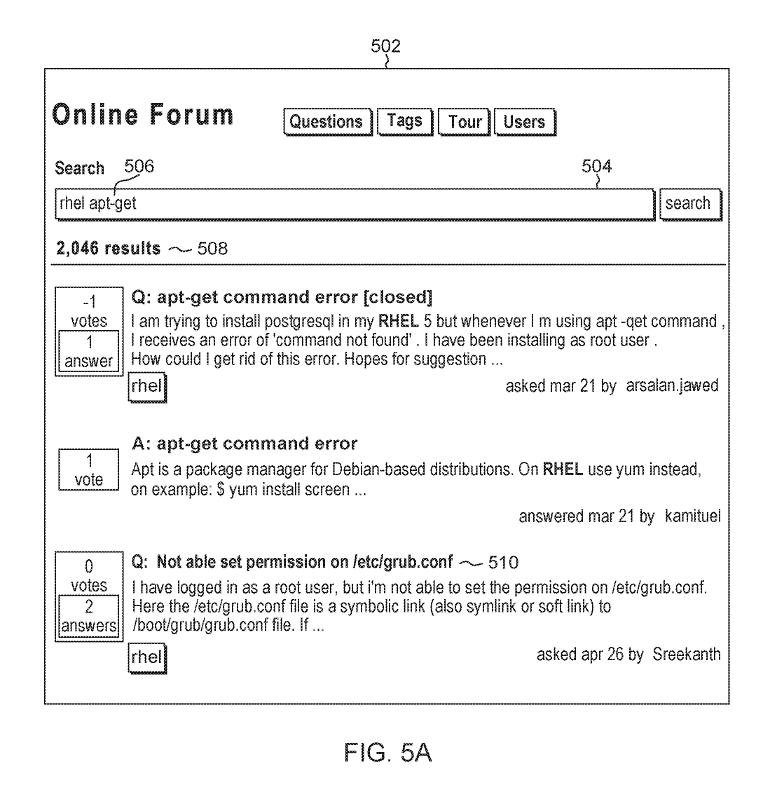

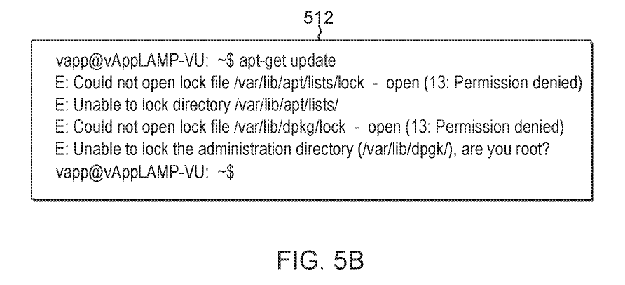

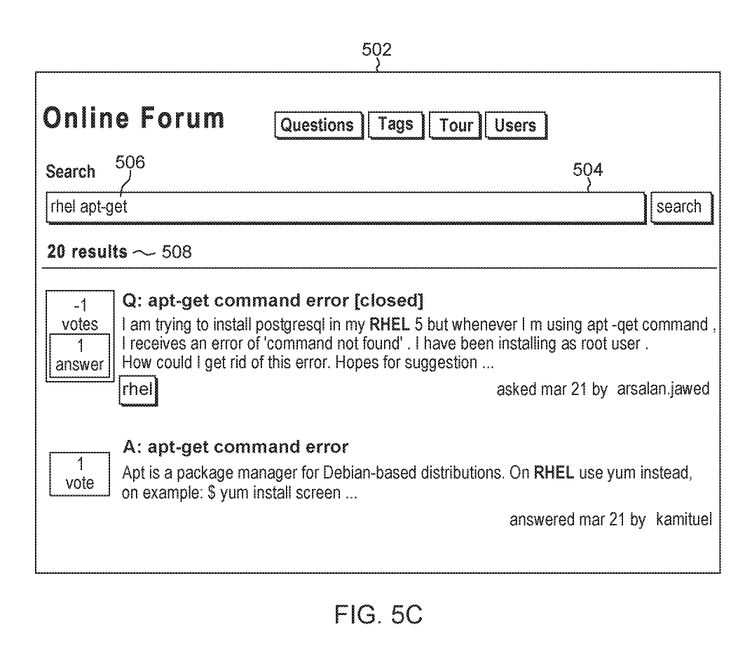

Content refining software 312 is a computer program, or sets of computer programs, that are stored in persistent storage 308. Content refining software 312 enables a user to view or highlight topics of interest within forum/community 310 based on the users or organization's active resources or recently posted topics or error and output messages (e.g., error message 512, as depicted in FIG. 5B) by the user, as discussed in greater detail with regard to FIG. 4. In this embodiment, the error and output messages include error messages, log messages, system failure messages, and installation results. The users or organizations active resources, recently posted topics or error messages can comprise one or more software and console output messages.

In FIG. 3, network 314 is shown as the interconnecting fabric between server 302, computer 316, and with various components and devices (not shown) within online support environment 300. In practice, the connection may be any viable data transport network, such as, for example, a LAN or WAN. Network 314 can be, for example, a local area network (LAN), a wide area network (WAN) such as the Internet, or a combination of the two, and include wired, wireless, or fiber optic connections. In general, network 314 can be any combination of connections and protocols that will support communications between server 302, computer 316, and with various components and devices (not shown) within online support environment 300.

Computer 316 is included in online support environment 300. Computer 316 includes random access memory (RAM) 318, central processing unit (CPU) 320, and persistent storage 322. Computer 316 may be a Web server, or any other electronic device or computing system, capable of processing program instructions and receiving and sending data. In some embodiments, computer 316 may be a laptop computer, a tablet computer, a netbook computer, a personal computer (PC), a desktop computer, a personal digital assistant (PDA), a smart phone, or any programmable electronic device capable of communicating over a data connection to network 314. In other embodiments, computer 316 may represent server computing systems utilizing multiple computers as a server system, such as in an online support environment. In general, computer 316 is representative of any electronic devices or combinations of electronic devices capable of executing machine-readable program instructions and communicating with server 302 via network 314 and with various components and devices (not shown) within online support environment 300.

Computer 316 includes persistent storage 322. Persistent storage 322 may, for example, be a hard disk drive. Alternatively, or in addition to a magnetic hard disk drive, persistent storage 322 may include a solid state hard drive, a semiconductor storage device, read-only memory (ROM), erasable programmable read-only memory (EPROM), flash memory, or any other computer-readable storage medium that is capable of storing program instructions or digital information. Software 324 is stored in persistent storage 322, which also includes operating system software, as well as software that enables computer 316 to detect and establish a connection to server 302, and communicate with other computing devices (not shown) of online support environment 300 over a data connection on network 314.

FIG. 4 is a flowchart, generally designated flowchart 400, depicting operational steps of a search refining software on a server computer within the online support environment of FIG. 3, for highlighting topics of interest in an online forum based on active error/console messages and/or cloud resource activity, in an embodiment in accordance with the present invention. FIGS. 5A-5C show diagrams illustrating content refining software 312 performing at least some of the method operations of flowchart 400.

In an example embodiment, a user of computer 316 interacts with an online forum (e.g., online forum 502 as depicted in FIG. 5A). For example, the user of computer 316 has experienced an error on one or more computing devices within online support environment 300 and enters relevant parameters in a search box (e.g., search field 504 as depicted by “rhel apt-get” 506). An online forum, such as online forum 502 then displays one or more results to the user as depicted by reference 508 illustrated in FIG. 5A. In this example embodiment, the user may enter a search string or a numerical value in search field 504.

Content refining software 312 identifies one or more system messages received by a user of a computer system in a cloud environment as depicted in step 402. For example, the user of computer 316 submits content relating to the error on the one or more computing devices as depicted in FIG. 5B, to online forum 502. In one example embodiment, content refining software 312 may automatically gather information from online support environment 300. For example, content refining software 312 may analyze one or more log files on one or more computing systems within online support environment 300 and determine a plurality of error or system messages relating to an “apt-get update” command. On one computing system within online support environment 300, content refining software 312 determines that the “apt-get update” command returned “E: Could not open file xyz . . . permission denied”. On another computing system, content refining software 312 determines that the “apt-get update” command returned “success” upon a file permission change of file “xzy”. On yet another system, content refining software 312 determines that the “apt-get update” command returned “E: network error . . . can't not reach to rhel satellite server”.

In step 404, content refining software 312 receives a request to view online community content. In this embodiment, content refining software 312 receives a request from a user of computer 316. For example, upon submitting information on an error message (e.g., error message 512, as depicted in FIG. 5B), the user of computer 316 may transmit a request to content refining software 312 to view online community content based on the entered command that resulted in error. Continuing the above example, the user of computer 316 can enter the command that resulted in error (e.g., “rhel apt-get” 506, as depicted in FIG. 5C) in a search field (e.g., search field 504, as depicted in FIG. 5C). In other embodiments, content refining software 312 can receive a request from one or more other components of online support environment 300.

Content refining software 312 analyzes the online community content to determine if one or more messages of the online community content match one or more system messages in the cloud environment as depicted in step 406. For example, content refining software 312 may search online forum 502 based on the entered search string “rhel apt-get” 506. In other example embodiments, upon submitting information associated with an error message (e.g., error message 512), content refining software 312 may automatically search online forum 502 for similar content. For example, the user may enter the following search string “rhel apt-get” 506.

In decision step 408, content refining software 312 determines if the one or more messages of the online community content match one or more system messages in the cloud environment. For example, content refining software 312 may compare the search string “rhel apt-get” 506 with one or more topics, or discussion threads, within online forum 502. In one example embodiment, content refining software 312 may use search string “rhel apt-get” 506 as a single string when searching the one or more topics, or discussion threads, within online forum 502. In another example embodiment, content refining software 312 may use portions of search string “rhel apt-get” 506 when searching the one or more topics, or discussion threads, within online forum 502.

If content refining software 312 determines that one or more messages of the online community content do not match one or more system messages in the cloud environment (“No” branch, decision step 408), content refining software 312 orders the one or more messages of the online community content as they are found as depicted in step 410. For example, upon receiving one or more search results, content refining software 312 may order the one or more messages of the online community content, to be viewed from top-to-bottom, as they are found.

If content refining software 312 determines that one or more messages of the online community content match one or more system messages in the cloud environment (“Yes” branch, decision step 408), content refining software 312 places a weighing metric on the one or more messages of the online community content as depicted in step 412. In this embodiment, a weight is a measure of relevance to a user's search string (e.g., “rhel apt-get” 506). In this embodiment, a weight is assigned for each respective content item. For example, a content item assigned a higher weight indicates that it would be of higher user interest than a content item having a lower weight. In this embodiment, a numerical weighting scale is used, where lower numbers represent lesser weights and higher numbers represent greater weights. In other embodiments any desirable weighting scale can be used.

Content refining software 312 orders the one or more messages of the online community content based on the assigned weighing metric as depicted in step 414. For example, content refining software 312 may order the one or more messages of the online community content according to the assigned highest weight. In other example embodiments, content refining software 312 may order the one or more messages of the online community content according to a predetermined, or predefined ordering preference, configured by the user of computer 316. For example, the ordering may be determined by a user profile setting that content refining software 312 may determine when a user logs into server 302.

In step 416, content refining software 312 displays the one or more messages of the online community content to the user of the computer system. For example, content refining software 312 may display the one or more messages of the online community content according to the assigned weight on a user interface, such as a display monitor (not shown), as depicted in FIG. 5C. In other instances, content refining software 312 can exclude content items based on the assigned weight (e.g., deemed as having little or no relevance to the error and output messages). In other example embodiments, content refining software 312 may monitor one or more online social media accounts of the user of computer 316. Upon posting one or more messages to the one or more online social media accounts, content refining software 312 may search online forum 502 based on one or more posted messages on the one or more online social media accounts then assign one or more weighing metric to a plurality of messages of online forum 502 that are determined to be similar to the one or more messages to the one or more online social media accounts.

In an alternate embodiment, where content refining software 312 automatically monitors a one or more cloud networked computing devices, such as online support environment 300, and gathers information, such as one or more error and output messages, content refining software 312 can automatically present a user with search results that pertain to the current running environment of online support environment 300 upon logging into online forum 502. In this alternate embodiment, content refining software 312 automatically presents a user with search results that pertain to the current running environment by monitoring error and output messages, and responsive detecting the error and output messages, and/or additional features such as operating systems and system configurations, filtering online community content (e.g., online forum 502), based on a relevance to the detected error and output messages. For example, content refining software 312 can determine that one or more messages of the online community content matches the one or more detected error and output messages. Accordingly, content refining software 312 can then display the one or more matching messages of the plurality of messages of the community content in accordance with a prioritization scheme (e.g., the weighting scheme described in decision step 408 of flowchart 400).

FIG. 6 depicts a block diagram, generally designated 600, of components of the server computer executing the search refining software, in an embodiment in accordance with the present invention. It should be appreciated that FIG. 6 provides only an illustration of one implementation and does not imply any limitations with regard to the environments in which different embodiments may be implemented. Many modifications to the depicted environment may be made.

Server 302 includes communications fabric 602, which provides communications between computer processor(s) 604, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses.

Memory 606 and persistent storage 608 are computer readable storage media. In this embodiment, memory 606 includes random access memory (RAM) 614 and cache memory 616. In general, memory 606 can include any suitable volatile or non-volatile computer readable storage media.

Forum/community 310 and content refining software 312 are stored in persistent storage 608 for execution and/or access by one or more of the respective computer processors 604 via one or more memories of memory 606. In this embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of persistent storage 608.

Communications unit 610, in these examples, provides for communications with other data processing systems or devices, including resources of network 314 and computer 316. In these examples, communications unit 610 includes one or more network interface cards. Communications unit 610 may provide communications through the use of either or both physical and wireless communications links. Forum/community 310 and content refining software 312 may be downloaded to persistent storage 608 through communications unit 610.

I/O interface(s) 612 allows for input and output of data with other devices that may be connected to server 302. For example, I/O interface 612 may provide a connection to external devices 618 such as a keyboard, keypad, a touch screen, and/or some other suitable input device. External devices 618 can also include portable computer readable storage media such as, for example, thumb drives, portable optical or magnetic disks, and memory cards. Software and data used to practice embodiments of the present invention, e.g., forum/community 310 and content refining software 312, can be stored on such portable computer readable storage media and can be loaded onto persistent storage 608 via I/O interface(s) 612. I/O interface(s) 612 also connect to a display 620.

Display 620 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Definitions

“Present invention” does not create an absolute indication and/or implication that the described subject matter is covered by the initial set of claims, as filed, by any as-amended set of claims drafted during prosecution, and/or by the final set of claims allowed through patent prosecution and included in the issued patent. The term “present invention” is used to assist in indicating a portion or multiple portions of the disclosure that might possibly include an advancement or multiple advancements over the state of the art. This understanding of the term “present invention” and the indications and/or implications thereof are tentative and provisional and are subject to change during the course of patent prosecution as relevant information is developed and as the claims may be amended.

“Embodiment,” see the definition for “present invention.”

“And/or” is the inclusive disjunction, also known as the logical disjunction and commonly known as the “inclusive or.” For example, the phrase “A, B, and/or C,” means that at least one of A or B or C is true; and “A, B, and/or C” is only false if each of A and B and C is false.

A “set of” items means there exists one or more items; there must exist at least one item, but there can also be two, three, or more items. A “subset of” items means there exists one or more items within a grouping of items that contain a common characteristic.

A “plurality of” items means there exists at more than one item; there must exist at least two items, but there can also be three, four, or more items.

“Includes” and any variants (e.g., including, include, etc.) means, unless explicitly noted otherwise, “includes, but is not necessarily limited to.”

A “user” includes, but is not necessarily limited to: (i) a single individual human; (ii) an artificial intelligence entity with sufficient intelligence to act in the place of a single individual human or more than one human; (iii) a business entity for which actions are being taken by a single individual human or more than one human; and/or (iv) a combination of any one or more related “users” or “subscribers” acting as a single “user” or “subscriber.”

The terms “receive,” “provide,” “send,” “input,” “output,” and “report” should not be taken to indicate or imply, unless otherwise explicitly specified: (i) any particular degree of directness with respect to the relationship between an object and a subject; and/or (ii) a presence or absence of a set of intermediate components, intermediate actions, and/or things interposed between an object and a subject.

A “module” is any set of hardware, firmware, and/or software that operatively works to do a function, without regard to whether the module is: (i) in a single local proximity; (ii) distributed over a wide area; (iii) in a single proximity within a larger piece of software code; (iv) located within a single piece of software code; (v) located in a single storage device, memory, or medium; (vi) mechanically connected; (vii) electrically connected; and/or (viii) connected in data communication. A “sub-module” is a “module” within a “module.”

A “computer” is any device with significant data processing and/or machine readable instruction reading capabilities including, but not necessarily limited to: desktop computers; mainframe computers; laptop computers; field-programmable gate array (FPGA) based devices; smart phones; personal digital assistants (PDAs); body-mounted or inserted computers; embedded device style computers; and/or application-specific integrated circuit (ASIC) based devices.

“Automatically” means “without any human intervention.”

“Content item” describes content in an online community. A content item can include, but is not limited to messages, images, video, audio, or any other form of media in an online community and/or forum. For example, content items can include messages of an electronic message thread.

What is claimed is:

1. A computer-implemented method comprising:
identifying error messages from software running on a cloud instance, wherein the error messages include log messages, system failure messages, console output messages, and installation results;
in response to identifying the error messages from software running on the cloud instance, automatically determining relevance of content items of community content to the identified error messages by identifying a plurality of content items of the community content and determining that one or more content items of the plurality of the content items of the community content match a search string or a numerical value associated with an error indicated by the one or more error messages, wherein the community content includes a forum, a blog, a wiki, a search engine, a support portal, and a social networking site, and wherein the content items include a message, a post, a status update, a search result, and a web page;
in response to automatically determining relevance of the content items of the community content to the identified error messages, automatically identifying features of a user's computer system, wherein the features include operating system and system configuration;
in response to automatically identifying features of the user's computer system, further automatically determining the relevance of the content items of the community content to the identified error messages based on the identified additional features;
in response to further automatically determining the relevance of the content items of the community content to the identified error messages based on the identified additional features, automatically assigning weights to the content items of the community content based on their determined relevance, wherein content items having high relevance to the identified error messages are assigned a higher weight than content items determined not relevant to the error messages; and
in response to automatically assigning weights to the content items of the community content based on their determined relevance, automatically displaying the content items according to the assigned weights.
